(19) United States
(12) Patent Application Publication
(10) Pub. No.: US 2021/0279597 A1
(43) Pub. Date: Sep. 9, 2021

(54) SYSTEM FOR PREDICTIVE MAINTENANCE USING DISCRIMINANT GENERATIVE ADVERSARIAL NETWORKS

(71) Applicant: Hitachi, Ltd., Tokyo (JP)

(72) Inventors: Shuai ZHENG, San Jose, CA (US); Chetan GUPTA, San Mateo, CA (US)

(73) Assignee: Hitachi, Ltd.

(21) Appl. No.: 17/066,199

(22) Filed: Oct. 8, 2020

Related U.S. Application Data
(63) Continuation-in-part of application No. 16/812,088, filed on Mar. 6, 2020.

(51) Int. Cl. G06N 3/08; G06N 3/04

(52) U.S. Cl. CPC G06N 3/088; G06N 3/0454

(57) ABSTRACT

Example implementations described herein involve a system for Predictive Maintenance using Discriminant Generative Adversarial Networks, and can involve providing generated sensor data and real sensor data to a first network and to a second network, the first network configured to enforce a discriminant loss objective of the second network, the second network configured to distinguish between the generated sensor data and the real sensor data, the first network including a subset of layers from the second network, the real sensor data including pairs of real sensor data and labels, the second network integrated into a generative adversarial network (GAN); training the machine health classification model from the output of the first network using the provided generated sensor data and the real sensor data, the output of the first network including feature vectors; and deploying the machine health classification model with the first network.

### CROSS-REFERENCE TO RELATED APPLICATIONS

This application is a Continuation-in-part of U.S. patent application Ser. No. 16/812,088, filed Mar. 6, 2020, the contents of which are incorporated herein by reference in its entirety for all purposes.

### BACKGROUND

### Field

The present disclosure is directed to predictive maintenance, and more specifically, to a system for predictive maintenance using Discriminant Generative Adversarial Networks (GAN).

### Related Art

Maintenance is a process in which the objective is to keep the equipment in a working, efficient and cost-effective condition. The maintenance process is conducted by performing the necessary actions on the equipment in order to achieve one or more of these objectives. These actions include, but are not limited to, the inspection, tuning, repair and overhaul of the equipment or its components. Maintenance actions are typically conducted according to one or more of the following strategies.

Corrective maintenance takes corrective actions after the equipment or one of its components fails in order to retain its working status. As this strategy waits for the equipment to fail before taking a maintenance action, this results in decreasing the availability of the equipment. In addition, it is usually more expensive and time-consuming to perform the corrective actions after the equipment failure.

Preventive maintenance (also known as, time-based maintenance) performs maintenance actions on a regular basis regardless of the condition of the equipment. This is the most commonly followed strategy for equipment maintenance. Preventive maintenance avoids the limitations of corrective maintenance by performing periodic maintenance actions (e.g., periodic replacement of parts). However, this strategy can be expensive as most of the periodic maintenance actions are done while the equipment is in a good condition, and such maintenance could have been avoided if the actual condition of the equipment is known while planning for maintenance. Moreover, the equipment is still prone to unexpected failures that might happen due to abnormal usage patterns or environmental conditions in between maintenance actions.

Predictive maintenance (also known as, condition-based maintenance) continually monitors the condition of the equipment to determine the right maintenance actions need to be taken at the right times. Predictive maintenance approaches mainly depend on encoding information about pre-failure conditions of the equipment and then monitoring real-time sensor and event data searching for these conditions. Predictive maintenance reduces the chance of unexpected failures, increases the equipment availability, and accordingly decreases the overall cost of the maintenance process.

One of the main objectives of predictive maintenance is to prevent failures before they happen. This is typically done by monitoring the equipment and searching for any pre-failure patterns. Traditionally, this monitoring process was done manually through visual inspection of equipment or using monitoring tools such as vibration monitoring and ultrasonics devices. With the advancement with operation and information technologies, most of the equipment are now instrumented with hundreds of sensors, and a lot of measurements are produced every fraction of a second. These measurements contain valuable information about the status of the equipment and it can be used to detect early signs of failures before they happen.

Data-driven predictive maintenance outperforms other methods by using equipment sensor data. The prerequisite is that a lot of sensor data for machines in various conditions are available for model training. However, many types of sensor data are rare and difficult to collect. This is because physical equipment and systems are engineered not to fail and as a result failure data is rare and difficult to collect. Further, failure data is extremely costly to collect. For example, it is not feasible to collect failure data from operating aircraft engines.

In practice, complex physical systems have multiple failure and degradation modes, often depending upon varying operating conditions. Thus those data have very complex patterns. Due to the lack of failure sensor data, and complex patterns of sensor data, Generative Adversarial Networks (GANs) are used to generate failure data.

In related art implementations, oversampling (e.g., SMOTE—Synthetic Minority Over-Sampling Technique, ADASYN—Adaptive Synthetic Sampling approach) has been used to create more training samples. However, oversampling cannot capture the complexity of the failure patterns and can easily introduce undesirable noise with overfitting risks due to the limitation of oversampling models. GAN was used in the related art to generate realistic data samples.

InfoGAN can be used to generate data with fine variations. InfoGAN decomposes the input noise vector into two parts: noise vector z and latent code vector c. The latent code vector c targets the salient structured semantic features of the data distribution and can be further divided into categorical and continuous latent code, where the categorical code controls sample labels and continuous code controls variations.

FIG. 1 illustrates an example structure of infoGAN, which involves network G, D and Q. Network G is a deep neural network with input (z,c), and outputs generated sample x′, where x′ has the same size as real data x. Network D aims to distinguish generated sample x′ from real sample x. Network Q aims to maximize the mutual information between latent code c and generated sample x′. By jointly training network G, D and Q, infoGAN solves the minimax problem with respect to the infoGAN loss function L1. L1 is the loss of infoGAN.

### SUMMARY

In machine health classification and predictive maintenance tasks, sensors for machines in different health stages are not equally different. For example, sensors for normal machines are more similar to sensors in degradation machines, than that of machines in critical stages. Existing GAN frameworks, including infoGAN, do not take these challenges into consideration. Due to the limitations of existing GANs, the example implementations described herein are directed to Discriminant GANs, wherein a discriminant loss is enforced on the generated samples. This improves the quality of the generated samples and improves the accuracy of predictive maintenance tasks.

Example implementations described herein involve a sensor generation system using Discriminant GANs, which can generate high quality of sensor data for machines in different health levels. The example implementations then use these generated sensor data to improve data-driven predictive maintenance models. In Discriminant GANs, a discriminant loss is enforced on the generated samples. This improves the quality of the generated samples and improves accuracy of predictive maintenance tasks.

Machine health prediction is a critical part of predictive maintenance. In machine health classification, the example implementations classify the health levels of machines into one of three stages: normal, degradation, critical. It is possible to introduce more health levels for this task. Based on the machine health status, the example implementations can assign different maintenance strategies for machines in different health levels. This could increase maintenance effectiveness and reduce maintenance cost.

Aspects of the present disclosure involve a method for training and deploying a machine health classification model, the method involving providing generated sensor data and real sensor data to a first network and to a second network, the first network configured to enforce a discriminant loss objective of the second network, the second network configured to distinguish between the generated sensor data and the real sensor data, the first network including a subset of layers from the second network, the real sensor data including pairs of real sensor data and labels, the second network integrated into a generative adversarial network (GAN); training the machine health classification model from the output of the first network using the provided generated sensor data and the real sensor data, the output of the first network including feature vectors; and deploying the machine health classification model with the first network, the deployed first network configured to intake the real sensor data to output the feature vectors to the machine health classification model.

Aspects of the present disclosure involve a non-transitory computer readable medium, storing instructions for training and deploying a machine health classification model, the instructions involving providing generated sensor data and real sensor data to a first network and to a second network, the first network configured to enforce a discriminant loss objective of the second network, the second network configured to distinguish between the generated sensor data and the real sensor data, the first network including a subset of layers from the second network, the real sensor data including pairs of real sensor data and labels, the second network integrated into a generative adversarial network (GAN); training the machine health classification model from the output of the first network using the provided generated sensor data and the real sensor data, the output of the first network including feature vectors; and deploying the machine health classification model with the first network, the deployed first network configured to intake the real sensor data to output the feature vectors to the machine health classification model.

Aspects of the present disclosure involve a system for training and deploying a machine health classification model, the system involving means for providing generated sensor data and real sensor data to a first network and to a second network, the first network configured to enforce a discriminant loss objective of the second network, the second network configured to distinguish between the generated sensor data and the real sensor data, the first network including a subset of layers from the second network, the real sensor data including pairs of real sensor data and labels, the second network integrated into a generative adversarial network (GAN); means for training the machine health classification model from the output of the first network using the provided generated sensor data and the real sensor data, the output of the first network including feature vectors; and means for deploying the machine health classification model with the first network, the deployed first network configured to intake the real sensor data to output the feature vectors to the machine health classification model.

Aspects of the present disclosure can involve an apparatus configured for training and deploying a machine health classification model, the apparatus involving a processor, configured to provide generated sensor data and real sensor data to a first network and to a second network, the first network configured to enforce a discriminant loss objective of the second network, the second network configured to distinguish between the generated sensor data and the real sensor data, the first network including a subset of layers from the second network, the real sensor data including pairs of real sensor data and labels, the second network integrated into a generative adversarial network (GAN); train the machine health classification model from the output of the first network using the provided generated sensor data and the real sensor data, the output of the first network including feature vectors; and deploy the machine health classification model with the first network, the deployed first network configured to intake the real sensor data to output the feature vectors to the machine health classification model.

### BRIEF DESCRIPTION OF DRAWINGS

FIG. 1 illustrates an example structure of infoGAN.

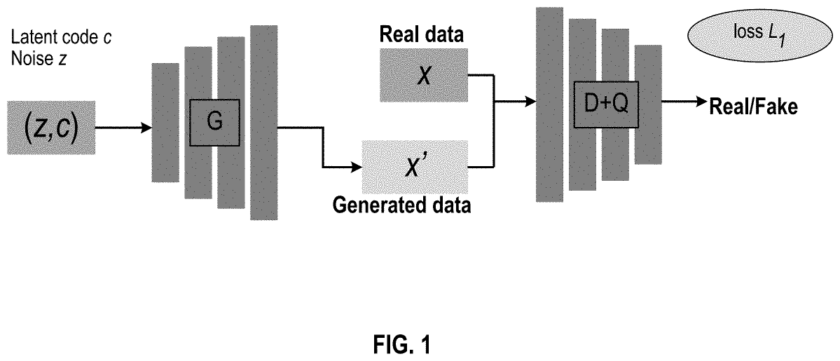

FIG. 2 illustrates the design of Discriminant infoGAN, in accordance with an example implementation.

FIG. 3 illustrates the example training flow for the Discriminant infoGAN, in accordance with an example implementation.

FIG. 4 illustrates an example flow diagram for the application phase, in accordance with an example implementation.

FIG. 5 illustrates an example flow diagram for conducting machine health classification through using generated sensor data, in accordance with an example implementation.

FIG. 6 illustrates a system involving a plurality of apparatuses and a maintenance planning apparatus, in accordance with an example implementation.

FIG. 7 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

The example implementations involve a system for maintenance recommendation based on machine health classification. In the example implementations described herein, a system to generate high quality sensor data using Discriminant Generative Adversarial Networks is proposed, and then such data is used to build machine health prediction models.

### Generating Realistic Sensor Data Using Discriminant GANs

Example implementations take infoGAN as an example to show how to enforce discriminant loss. This design can be similarly extended to other GAN frameworks, including conditional GAN (CGAN), Wasserstein GAN (WGAN), and so on in accordance with example implementations described herein.

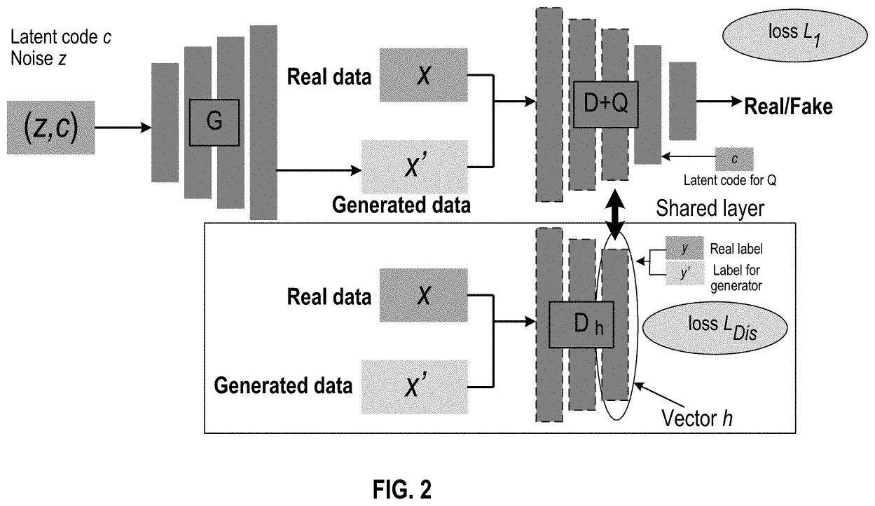

FIG. 2 illustrates the design of Discriminant infoGAN, in accordance with an example implementation. The upper network is standard infoGAN, loss L1. Input c is categorical latent code and z is noise vector z. Network G is a deep neural network with input (z,c), and outputs generated sample x′. By jointly training network G, D and Q, the upper network solves the minimax problem with respect to infoGAN loss function L1:

$${min}_{G} {max}_{D} {L}_{1} , \qquad ( 1 )$$

where L1 is the loss of infoGAN. This network allows other variations of GANs as well, such as CGAN, WGAN, etc.

The lower shaded network enforces discriminative loss: real data x and generated data x′ are used to compute loss L_{Dis}. Suppose there are K classes in total. Each class can be a health stage. Let mₖ be the mean of all hᵢ for class k, k=1, 2, . . . , K. Let m be the total mean of hᵢ, for all classes. The discriminative loss objective is given as:

$${min}_{G , {D}_{h}} {L}_{D i s} = \frac{{\sum }_{k = 1}^{K} {\sum }_{{h}_{i} ∈ k} {‖ {h}_{i} - {m}_{k} ‖}_{2}^{2}}{{\sum }_{k = 1}^{K} {n}_{k} {‖ {m}_{k} - m ‖}_{2}^{2}} \qquad ( 2 )$$

hᵢ, mₖ, m are functions of G and Dₕ. Combining this regularization with infoGAN loss, the objective function of discriminative infoGAN is given as:

$${min}_{G , {D}_{h}} {max}_{D} {L}_{1} + λ {L}_{D i s} \qquad ( 3 )$$

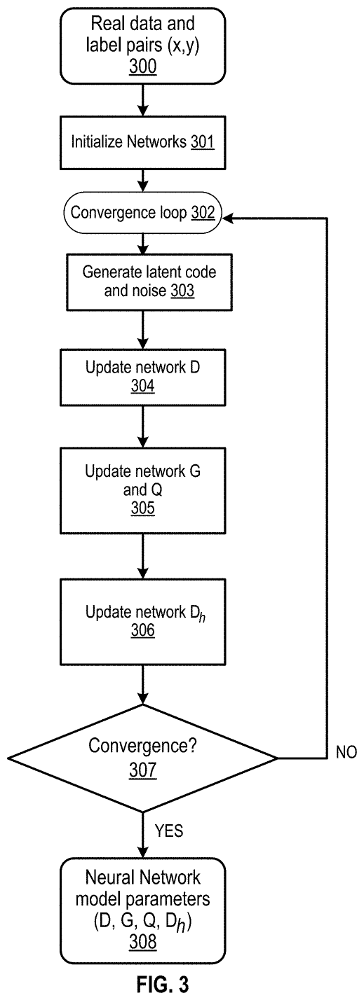

Training flow for the design in FIG. 2 is illustrated in FIG. 3.

In the training phase, all networks in FIG. 2 will be updated. In the application phase, network G will be used to generate samples, network Dₕ will be used to train machine health prediction models. Through the enforcement of the discriminant loss objective as described herein, it is thereby feasible to create a machine health prediction model that can distinguish between multiple types of health states (e.g., healthy, different states of degradation, failure), as opposed to failure/non-failure as would be conducted in failure-prediction models. Thus, degradation states can be detected and predicted in advance to facilitate predictive maintenance in a more accurate manner than would be found in the related art implementations.

### Machine Health Prediction Using Generated Sensor Data

To build efficient machine health prediction models, example implementations combine real sensor data with the generated sensor data using Discriminant infoGANs and train machine health prediction models, such as linear regression, DNN, LSTM, SVM, etc. The sensor data are first input into the trained network Dₕ from FIG. 2. Network Dₕ is optional.

FIG. 3 illustrates the example training flow for the discriminant infoGAN, in accordance with an example implementation. As illustrated in FIG. 3, the flow diagram as illustrated is configured to optimize the structure of FIG. 2. The input 300 for the flow is the real data and label pairs (x, y). The output 308 is the neural network parameters (D, G, Q, Dₕ) which can be utilized for the predictive maintenance predictions.

At 301, the networks of FIG. 2 are initialized. At 302, a loop is initiated until convergence is reached by randomly selecting a batch of data and label pairs from the real data. At 303, the flow randomly generates latent code c and noise z, wherein c is class-balanced.

At 304, network D is updated by solving Eq. (3), wherein the weights of the first few layers are shared with network Dₕ. At 305, the networks G and Q are updated by solving Eq. (3). At 306, the network Dₕ is updated by solving Eq. (3). At 307, a determination is made as to whether a convergence has been reached or not. If not (No) the loop is reiterated at 302. Otherwise (Yes), the flow proceeds to 308 to output the neural network parameters.

In the training phase, all of the networks in FIG. 2 are thereby updated. In the application phase, network G will be used to generate samples, and network Dₕ will be used to train machine health classification models.

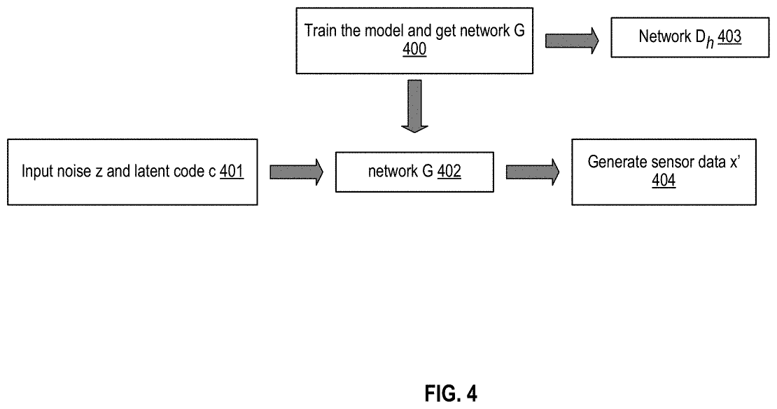

FIG. 4 illustrates an example flow diagram for the application phase, in accordance with an example implementation. As shown in FIG. 4, at 400, the flow diagram of FIG. 3 is invoked to train the model in FIG. 2 to obtain network G at 402 and network Dₕ at 403. At 401, the flow randomly generates latent code c and noise z, which is provided to network G as shown in FIG. 2. At 404, network G produces sensor data x′ as illustrated in FIG. 2.

For conducting machine health classification through using generated sensor data, to build efficient machine health classification models, example implementations combine real sensor data with the generated sensor data using Discriminant GANs and train machine health classification models, such as linear regression, DNN, Long Short Term Memory (LSTM), Support Vector Machines (SVM), and so on in accordance with the desired implementation. The sensor data is first input into the trained network Dₕ from FIG. 2. Depending on the desired implementation, network Dₕ can also be optional.

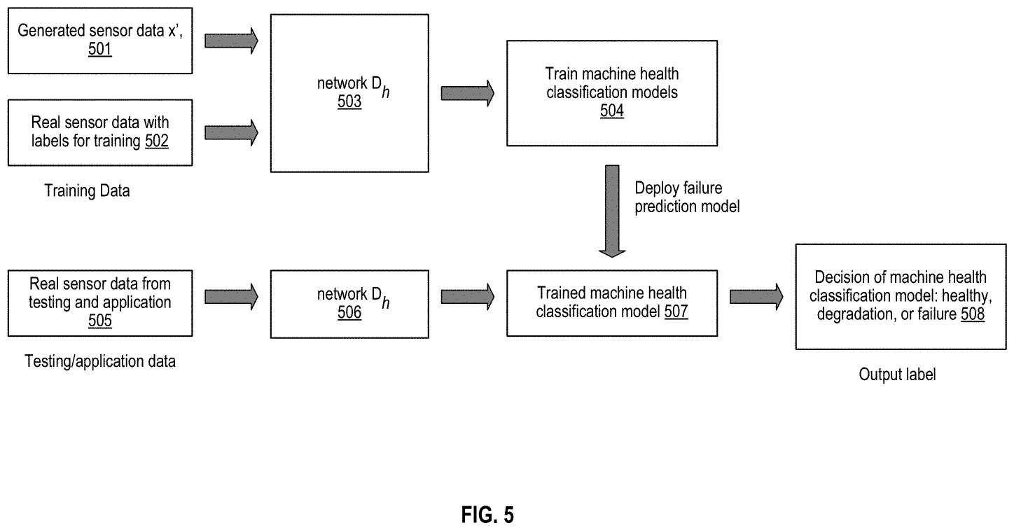

FIG. 5 illustrates an example flow diagram for conducting machine health classification through using generated sensor data, in accordance with an example implementation.

As illustrated in FIG. 5, training data is provided for training network Dₕ at 503. The training data can include the generated sensor data x′ 501 as illustrated in FIG. 2 and the real sensor data with labels for training 502. The output from network Dₕ is then used to train machine health classification models, such as linear regression, DNN, and so on at 504 depending on the desired implementation. Once the machine health classification models are trained, the machine health classification model is deployed at 507.

During the testing and application phase, real sensor data at 505 is provided to network Dₕ at 506. The output of network Dₕ is provided to the machine health classification model at 507, which then provides an output for machine health classification (i.e., healthy, degradation, failure) at 508.

Further, depending on the desired implementation, the infoGAN of FIG. 2 can be modified to facilitate any other type of GAN to generate healthy, degradation, or failure samples in accordance with the desired implementation.

The example implementations described herein can thereby be utilized for maintenance personnel and management, data analysts and decision-support personnel, decision makers and operation managers, as well as equipment designers and manufacturers.

Further, the example implementations can be deployed in factories for predictive maintenance purpose. Such example implementations can be utilized for machine health classification (indicating health status of machines using sensor data), failure detection (monitoring systems for failure events), failure isolation (identifying the reasons and components of different type of failures), as well as for eliminating unnecessary maintenance actions, thereby saving parts and labor costs.

Depending on the desired implementation, the present disclosure can be used as a standalone solution or be integrated with existing systems that provide other functionalities for maintenance management and optimization.

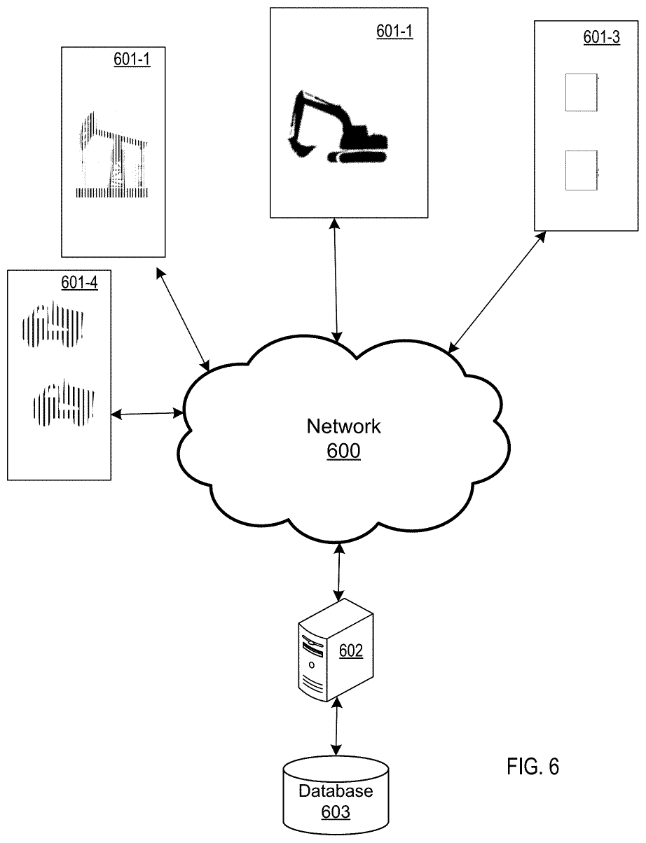

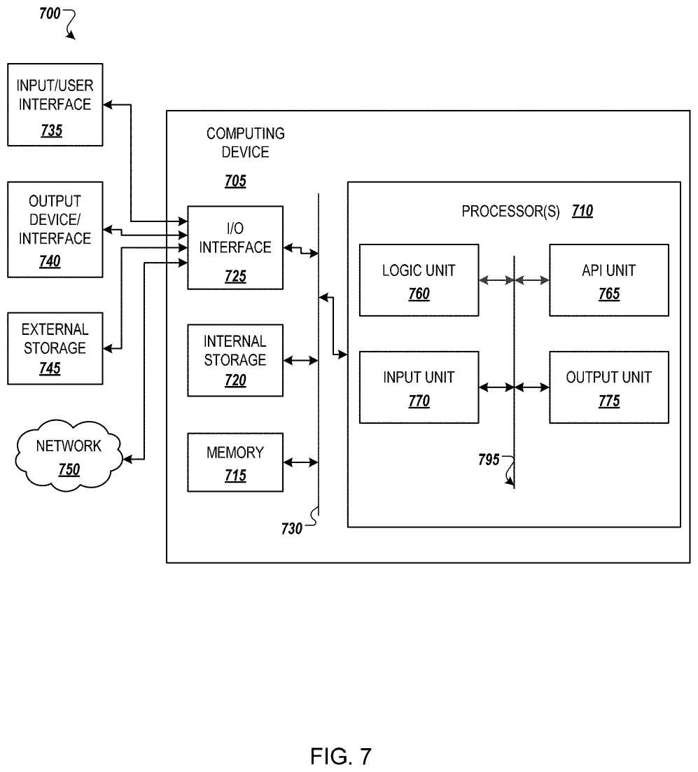

FIG. 6 illustrates a system involving a plurality of apparatuses and a maintenance planning apparatus, in accordance with an example implementation. One or more apparatuses or apparatus systems 601-1, 601-2, 601-3, and 601-4 are communicatively coupled to a network 600 which is connected to a maintenance planning apparatus 602. The maintenance planning apparatus 602 manages a database 603, which contains historical data collected from the apparatuses and apparatus systems in the network 600. In alternate example implementations, the data from the apparatuses and apparatus systems 601-1, 601-2, 601-3, and 601-4 can be stored to a central repository or central database such as proprietary databases that data from equipment or equipment systems such as enterprise resource planning systems, and the maintenance planning apparatus 602 can access or retrieve the data from the central repository or central database. Such apparatuses can include stationary apparatuses or equipment such as coolers, air conditioners, servers, as well as mobile apparatuses or equipment such as automobiles, trucks, cranes, as well as any other apparatuses that undergo periodic maintenance. Such apparatuses can involve sensors to provide sensor data to the maintenance planning apparatus 602. In example implementations, the data from some of the apparatuses and apparatus systems may only be provided sparsely due to remoteness or general lack of connectivity (e.g., sensors with limited battery power or connectivity that connect to the network once a year to transmit data, sensors that only connect sparsely to the network due to bandwidth costs, such as cellular based sensors, etc.). As will be described in FIG. 7, the maintenance planning apparatus 602 is configured for training and deploying a machine health classification model configured to classify the health of the apparatuses or apparatus systems 601-1, 601-2, 601-3, and 601-4 managed by the maintenance planning apparatus 602 as healthy, degradation, or failure.

FIG. 7 illustrates an example computing environment with an example computer device suitable for use in some example implementations, such as a maintenance planning apparatus 602 as illustrated in FIG. 6. Computer device 705 in computing environment 700 can include one or more processing units, cores, or processors 710, memory 715 (e.g., RAM, ROM, and/or the like), internal storage 720 (e.g., magnetic, optical, solid state storage, and/or organic), and/or 10 interface 725, any of which can be coupled on a communication mechanism or bus 730 for communicating information or embedded in the computer device 705. IO interface 725 is also configured to receive images from cameras or provide images to projectors or displays, depending on the desired implementation.

Computer device 705 can be communicatively coupled to input/user interface 735 and output device/interface 740. Either one or both of input/user interface 735 and output device/interface 740 can be a wired or wireless interface and can be detachable. Input/user interface 735 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 740 may include a display, television, monitor, printer, speaker, braille, or the like. In some example implementations, input/user interface 735 and output device/interface 740 can be embedded with or physically coupled to the computer device 705. In other example implementations, other computer devices may function as or provide the functions of input/user interface 735 and output device/interface 740 for a computer device 705.

Examples of computer device 705 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 705 can be communicatively coupled (e.g., via 10 interface 725) to external storage 745 and network 750 for communicating with any number of networked components, devices, and systems, including one or more computer devices of the same or different configuration. Computer device 705 or any connected computer device can be functioning as, providing services of, or referred to as a server, client, thin server, general machine, special-purpose machine, or another label.

IO interface 725 can include, but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 700. Network 750 can be any network or combination of networks (e.g., the Internet, local area network, wide area network, a telephonic network, a cellular network, satellite network, and the like).

Computer device 705 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 705 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 710 can execute under any operating system (OS) (not shown), in a native or virtual environment. One or more applications can be deployed that include logic unit 760, application programming interface (API) unit 765, input unit 770, output unit 775, and inter-unit communication mechanism 795 for the different units to communicate with each other, with the OS, and with other applications (not shown). The described units and elements can be varied in design, function, configuration, or implementation and are not limited to the descriptions provided. Processor(s) 710 can be in the form of hardware processors such as central processing units (CPUs) or in a combination of hardware and software units.

In some example implementations, when information or an execution instruction is received by API unit 765, it may be communicated to one or more other units (e.g., logic unit 760, input unit 770, output unit 775). In some instances, logic unit 760 may be configured to control the information flow among the units and direct the services provided by API unit 765, input unit 770, output unit 775, in some example implementations described above. For example, the flow of one or more processes or implementations may be controlled by logic unit 760 alone or in conjunction with API unit 765. The input unit 770 may be configured to obtain input for the calculations described in the example implementations, and the output unit 775 may be configured to provide output based on the calculations described in example implementations.

Processor(s) 710 can be configured to provide generated sensor data and real sensor data to a first network (e.g., network Dh as illustrated in FIG. 2) and to a second network (e.g., network D or D+Q as illustrated in FIG. 2), the first network configured to enforce trace norm minimization of the second network, the second network configured to distinguish between the generated sensor data and the real sensor data, the first network involving a subset of layers from the second network as illustrated in FIG. 2, the real sensor data involving pairs of real sensor data and labels as illustrated at 300 of FIG. 3, the second network integrated into a generative adversarial network (GAN) as illustrated in FIG. 2; train the machine health classification model from the output of the first network from the provided generated sensor data and the real sensor data, the output of the first network involving feature vectors as illustrated in 501 to 504 of FIG. 5; and deploy the machine health classification model with the first network, the deployed first network configured to intake the real sensor data to output the feature vectors to the machine health classification model as illustrated at 505 to 508 of FIG. 5.

Processor(s) 710 can be configured to train the machine health classification model from the output of the first network by iteratively updating the first network and the second network based on loss between the generated sensor data and the real sensor data as determined for each of the first network and the second network until the loss of the first network converges with the loss of the second network as illustrated from 302 to 307 of FIG. 3; and provide neural network model parameters of the first network and the second network for the machine health classification model as illustrated at 308 of FIG. 3.

Processor(s) 710 can be configured to provide generated sensor data by providing an input noise vector into a third network configured to provide the generated sensor data as illustrated at 401 of FIG. 4, wherein the processor(s) 710 is configured to train the machine health classification model from the output by iteratively updating the third network (e.g., network G as illustrated in FIG. 2) with the first network and the second network based on loss between the generated sensor data and the real sensor data as determined for each of the first network and the second network until the loss of the first network converges with the loss of the second network as illustrated from 302 to 307 of FIG. 3.

Depending on the desired implementation the second network is integrated with another network (e.g., network Q as illustrated in FIG. 2) configured to maximize mutual information between latent code used to generate the generated sensor data and the generated sensor data wherein the processor is configured to train the machine health classification model from the output by iteratively updating the another network with the first network and the second network based on loss between the generated sensor data and the real sensor data as determined for each of the first network and the second network until the loss of the first network converges with the loss of the second network as illustrated at 302 to 307 of FIG. 3.

As illustrated at 200 of FIG. 2, the second network can be integrated into an infoGAN. As illustrated at 508 of FIG. 5, the machine health classification model is configured to output a label for the second sensor data as healthy, degradation, or failure. Accordingly, processor(s) 710 can be configured to execute a predictive maintenance process on the corresponding apparatus associated with the second sensor data based on the output label. For example, the corresponding apparatus may have different types of maintenance to be conducted depending on the type of degradation state, whereupon instructions are sent to the corresponding apparatus to conduct the particular maintenance (e.g., execute a particular maintenance operation, shut down, change the and on light signal to indicate the type of maintenance to be conducted, etc.)

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for training and deploying a machine health classification model, the method comprising:
providing generated sensor data and real sensor data to a first network and to a second network, the first network configured to enforce a discriminant loss objective of the second network, the second network configured to distinguish between the generated sensor data and the real sensor data, the first network comprising a subset of layers from the second network, the real sensor data comprising pairs of real sensor data and labels, the second network integrated into a generative adversarial network (GAN);
training the machine health classification model from the output of the first network using the provided generated sensor data and the real sensor data, the output of the first network comprising feature vectors; and
deploying the machine health classification model with the first network, the deployed first network configured to intake the real sensor data to output the feature vectors to the machine health classification model.

2. The method of claim 1, wherein training the machine health classification model from the output of the first network comprises iteratively updating the first network and the second network based on loss between the generated sensor data and the real sensor data as determined for each of the first network and the second network until the loss of the first network and the second network converges; and
wherein the instructions further comprise providing neural network model parameters of the first network and the second network for the machine health classification model.

3. The method of claim 1, wherein the providing generated sensor data comprises providing an input noise vector into a third network configured to provide the generated sensor data;
wherein the training the machine health classification model from the output comprises iteratively updating the third network with the first network and the second network based on loss between the generated sensor data and the real sensor data as determined for each of the first network and the second network until the loss of the first network and the second network converges.

4. The method of claim 1, wherein the second network is integrated with another network configured to maximize mutual information between latent code used to generate the generated sensor data and the generated sensor data;
wherein the training the machine health classification model from the output comprises iteratively updating the another network with the first network and the second network based on loss between the generated sensor data and the real sensor data as determined for each of the first network and the second network until the loss of the first network and the second network converges.

5. The method of claim 1, wherein the first network is integrated into an infoGAN.

6. The method of claim 1, wherein the machine health classification model is configured to output a label for the sensor data as healthy, degradation, or failure.

7. A non-transitory computer readable medium storing instructions for training and deploying a machine health classification model, the instructions comprising:
providing generated sensor data and real sensor data to a first network and to a second network, the first network configured to enforce a discriminant loss objective of the second network, the second network configured to distinguish between the generated sensor data and the real sensor data, the first network comprising a subset of layers from the second network, the real sensor data comprising pairs of real sensor data and labels, the second network integrated into a generative adversarial network (GAN);
training the machine health classification model from the output of the first network using the provided generated sensor data and the real sensor data, the output of the first network comprising feature vectors; and
deploying the machine health classification model with the first network, the deployed first network configured to intake the real sensor data to output the feature vectors to the machine health classification model.

8. The non-transitory computer readable medium of claim 7, wherein training the machine health classification model from the output of the first network comprises iteratively updating the first network and the second network based on loss between the generated sensor data and the real sensor data as determined for each of the first network and the second network until the loss of the first network and second network converges; and
wherein the method further comprises providing neural network model parameters of the first network and the second network for the machine health classification model.

9. The non-transitory computer readable medium of claim 7, wherein the providing generated sensor data comprises providing an input noise vector into a third network configured to provide the generated sensor data;
wherein the training the machine health classification model from the output comprises iteratively updating the third network with the first network and the second network based on loss between the generated sensor data and the real sensor data as determined for each of the first network and the second network until the loss of the first network and second network converges.

10. The non-transitory computer readable medium of claim 7, wherein the second network is integrated with another network configured to maximize mutual information between latent code used to generate the generated sensor data and the generated sensor data;
wherein the training the machine health classification model from the output comprises iteratively updating the another network with the first network and the second network based on loss between the generated sensor data and the real sensor data as determined for each of the first network and the second network until the loss of the first network and second network converges.

11. The non-transitory computer readable medium of claim 7, wherein the first network is integrated into an infoGAN.

12. The non-transitory computer readable medium of claim 7, wherein the machine health classification model is configured to output a label for sensor data as healthy, degradation, or failure.

13. An apparatus configured for training and deploying a machine health classification model, the apparatus comprising:
a processor, configured to:
provide generated sensor data and real sensor data to a first network and to a second network, the first network configured to enforce a discriminant loss objective of the second network, the second network configured to distinguish between the generated sensor data and the real sensor data, the first network comprising a subset of layers from the second network, the real sensor data comprising pairs of real sensor data and labels, the second network integrated into a generative adversarial network (GAN);
train the machine health classification model from the output of the first network using the provided generated sensor data and the real sensor data, the output of the first network comprising feature vectors; and
deploy the machine health classification model with the first network, the deployed first network configured to intake the real sensor data to output the feature vectors to the machine health classification model.

14. The apparatus of claim 13, wherein the processor is configured to train the machine health classification model from the output of the first network by iteratively updating the first network and the second network based on loss between the generated sensor data and the real sensor data as determined for each of the first network and the second network until the loss of the first network and second network converges; and
wherein the processor is further configured to provide neural network model parameters of the first network and the second network for the machine health classification model.

15. The apparatus of claim 13, wherein the processor is configured to provide generated sensor data by providing an input noise vector into a third network configured to provide the generated sensor data;
wherein the processor is configured to train the machine health classification model from the output by iteratively updating the third network with the first network and the second network based on loss between the generated sensor data and the real sensor data as determined for each of the first network and the second network until the loss of the first network and the second network converges.

16. The apparatus of claim 13, wherein the second network is integrated with another network configured to maximize mutual information between latent code used to generate the generated sensor data and the generated sensor data;
wherein the processor is configured to train the machine health classification model from the output by iteratively updating the another network with the first network and the second network based on loss between the generated sensor data and the real sensor data as determined for each of the first network and the second network until the loss of the first network and second network converges.

17. The apparatus of claim 13, wherein the first network is integrated into an infoGAN.

18. The apparatus of claim 13, wherein the machine health classification model is configured to output a label for sensor data as healthy, degradation, or failure.
